(19) United States
(12) Patent Application Publication
(10) Pub. No.: US 2004/0235442 A1
(43) Pub. Date: Nov. 25, 2004

(54) Method to block audio and data in a digital radio receiver

(76) Inventor: Todd A. Toporski, Northville, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/441,896

(22) Filed: May 19, 2003

(51) Int. Cl. H04B 1/18

(52) U.S. Cl. 455/166.1; 455/164.2; 455/158.5

(57) ABSTRACT

Locking out of an audio broadcast station at a target channel frequency is provided by using a block-out table containing undesirable program content as determined by an authorized user, wherein the authorized user constructs the block-out table containing an identifying data of the audio broadcast station and a microcontroller compares the identifying data of the audio broadcast station with an identifying data of an audio signal to determine if the program content should be blocked out or reproduced for a listener.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The present invention relates in general to digital audio broadcasting, and more specifically, to a method for blocking reproduction of undesirable multimedia content from a broadcast station in a radio receiver.

2. Description of the Related Art

The audio entertainment industry presents diverse types of content suiting a wide variety of tastes. A broadcast band for a geographical region can maintain a variety of audio broadcast stations playing various music genre as well as talk shows. Such genre may include rock, pop, alternative, classical, country, reggae, hip-hop, punk, oldies, big-band, barbershop, blues, choral, religious, opera and many others. Many listeners are devoted to certain types of music and desire to listen to a specific genre only. As the broadcast band becomes more populated with audio broadcast stations transmitting within a broadcast region, a listener's selection of the audio broadcast stations increases. As a result, unless the listener has desired audio broadcast stations programmed into the memory of a radio receiver, a period of time to locate a desired genre using a scan or a seek operation may also increase.

A further concern of listeners is the program content of talk shows and songs. Certain language or program material of a song or talk show may be deemed inappropriate by a parent for their children's listening. A parent attempting to monitor and control a song/station selection of their children/teenager is a difficult challenge. The parent may be able to monitor the listening choices in certain instances but there are various circumstances when monitoring is not available. Such a circumstance is when a vehicle is equipped with a rear seat controller which allows a rear seat passenger to listen to the radio over the headphones while another multimedia event is being output to the passenger speakers or while the passenger speakers are off. Under this circumstance, the parent may be unaware of what program content is currently being received or what audio broadcast station is being tuned in. Another circumstance is when a teenager is using the vehicle without a parent present. The parent has no means of monitoring the station selection of the teenager.

Therefore, it would be desirable to be able to block out certain undesirable audio broadcast stations both for convenience purposes of being able to customize a radio to only those audio broadcast stations preferred by the listener and for control of children's listening choices as deemed appropriate by an adult.

### SUMMARY OF THE INVENTION

Consonant with the present invention, a method is provided for locking out an audio broadcast station at a target channel frequency using a block-out table containing undesirable program content as determined by a listener, wherein the listener constructs the block-out table containing an identifying data of the audio broadcast station and a microcontroller compares the identifying data of the audio broadcast station with an identifying data of an audio signal to determine if the program content should be blocked out or output to a speakers.

In one aspect of the invention, a method is performed for blocking audio and multimedia data provided by the audio broadcast station in a radio receiver. The audio broadcast station provides the audio signal at a target frequency channel, wherein the audio signal contains a data signal. The receiver includes a tuner for selecting the frequency range of the target frequency channel and a decoder for decoding the data signal. The data signal contains an identifying data, wherein the identifying data relates to station and programming content of audio signal. The method includes identifying a target frequency channel to potentially receive the audio signal. The radio receiver is tuned to the target frequency channel that provides the audio signal. The data signal contained in the audio signal is decoded and the identifying data is retrieved from the data signal. A determination is made whether the identifying data in the audio signal matches the identifying data stored in a block-out table. The target frequency channel is locked out when the identifying data of the audio signal matches the identifying data of the block-out table.

### BRIEF DESCRIPTION OF THE DRAWINGS

FIG. 1 is a block diagram of a receiver for blocking out an audio broadcast station according to a first preferred embodiment.

FIG. 2 is a block-out table of identifying data indicating an audio broadcast stations to be blocked out.

FIG. 3 is a block-out table for the audio broadcast stations including designated block-out times.

FIG. 4 is block-out table of undesired genre to be blocked out.

FIG. 5 is a flow diagram of a method to block-out an audio broadcast station broadcasting undesirable program content.

FIG. 6 is a flow diagram of a method to construct a block-out table according to a first preferred embodiment.

FIG. 7 is a flow diagram of a method to construct a block-out table according to a second preferred embodiment.

### DETAILED DESCRIPTION OF PREFERRED EMBODIMENTS

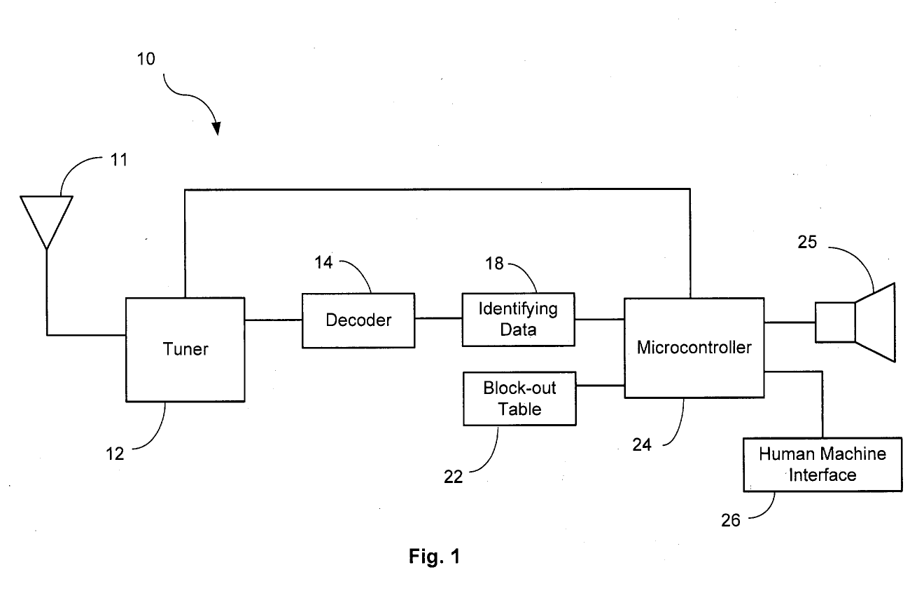

Referring now to the Drawings and particularly to FIG. 1, there is shown a block diagram of a radio receiver used to determine whether a target frequency channel broadcast by an audio broadcast station should be blocked out due to undesirable program content as determined by a listener. A receiver 10 comprises an antenna 11 for receiving an audio broadcast signal that is accompanied by a digital data signal providing program information, such as an RDS or an RBDS radio station. Alternatively, the broadcast can contain a hybrid signal. IBOC is a system that is capable of broadcasting the hybrid signal. The IBOC signal comprises the digital signal (primary channel) and an analog signal (backup channel) over a frequency range for a particular audio broadcast station. The analog signal is transmitted on a center band of the frequency range while the digital signal occupies upper and lower sideband portions of the frequency range. One or more tuners may be used to process the analog and digital signal over the frequency range.

A demodulator/decoder 14 is connected to a tuner 12 for decoding the audio broadcast signal containing an identifying data 18. The identifying data 18 includes identification codes relating to the station and programming content of the audio broadcast station and audio signal. The identification codes relating to the station and programming content of the audio broadcast station may be included in an analog broadcast using Radio Broadcast Data System (RBDS) technology or a may be included in a digital broadcast. RBDS uses various codes such as a PTY (Program Type), PTYN (Program Type Name), PI (Program Identification), PS (Program Service) to provide information concerning station and programming content of the analog signal. An RBDS data in the form of the PTY, PTYN, or other codes can be transmitted with the analog signal to indicate the identification codes of the audio broadcast station. Since the receiver 10 can decode an analog signal faster than decoding the digital signal, for efficiency of time, the analog signal can be decoded first in a hybrid system to determine if the identification codes are present. However, because the analog signal does not always contain the RBDS data, a digital decoding may need to be performed to retrieve the identifying data 18 of a digital signal whenever the identification codes of the analog signal are not present.

A microcontroller 24 receives the identifying data 18 containing the identification codes and compares the identification codes of the audio broadcast signal with the identification codes contained in a block-out table 22. The block-out table 22 contains a plurality of table entries of identification codes. The identification codes comprise a station call letters, a type of genre, or a block-out time for a designated audio broadcast station. The block-out table is stored in non-volatile memory, such as flash or battery-backed static ram (SRAM). Following a receiver power-up, the block-out table is loaded into scratch RAM where the block-out table may be updated at any time during the receiver operation. When the receiver is powered down or in standby mode, the updated data in the scratch RAM is written to the non-volatile memory locations.

If the microcontroller 24 determines that the block-out table 22 contains the identification codes contained in the audio broadcast signal, then the audio broadcast signal will either be locked out or muted depending upon the tuning function entered by the listener. For example, if the listener performs a manual tune operation (selectively dialing up or down between stations) or a memory preset operation to a target frequency channel and the micocontroller 24 determines that the identification codes exist in the block-out table, the microcontroller 24 will mute the audio output and a message can be displayed on a human machine interface 26 indicating that the target frequency channel selected is locked out. The listener will then have to select a new target frequency channel. The human machine interface 26 includes outputs, such as a display, and inputs, such as the tuning inputs, volume inputs, block-out table inputs and other inputs associated with radio receiver controls.

If the listener performs a scan or a seek operation, during the time the tuner 12 is attempting to select and lock on to a next target frequency channel, the radio is temporarily muted so that no audio is heard through a receiver units 25 such as a speaker. If the microcontroller 24 determines that identification codes relating to the next target frequency channel are contained in the block-out table 22, then the next target frequency channel is bypassed without any indication to the listener and a next successive frequency channel is searched for by the receiver 10. If the identification codes of the block-out table 22 and the audio broadcast signal do not match, then the audio is output to the receiver units 25 (assuming the audio broadcast signal otherwise matches any criteria being used for the scan or seek operation).

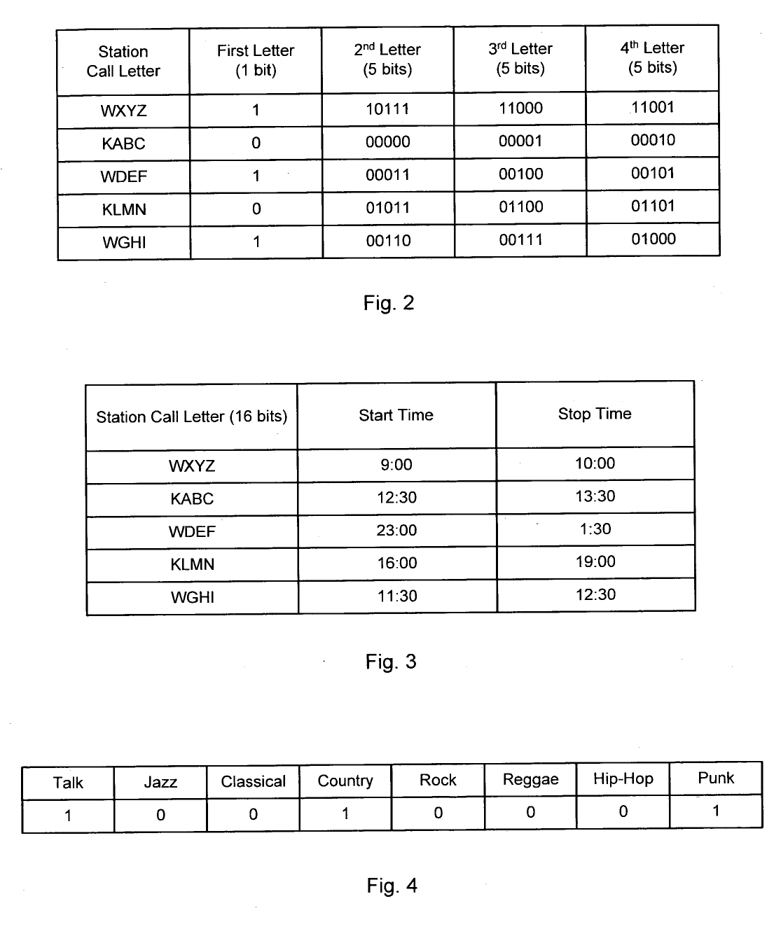

FIG. 2 illustrates a block-out table of audio broadcast stations coded in binary format. The block-out table is stored in the nonvolatile memory of the receiver 10. The block-out table 22 contains a plurality of table entries. Each of the table entries contains a designated audio broadcast station that will be blocked out as commanded by an authorized user. The user can either select the target frequency channel from a list or tune to the target frequency channel broadcasting the undesired audio content and command that the target frequency channel be added to the block-out table. The identification codes (e.g., call letters) are entered into the block-out table 22 and stored in binary code. In this embodiment, 16 bits would be required to appropriately store the call letters in a binary format, since the call letter comprise 4 alphabet letters. For example, a first letter will either begin with a “K” or a “W” where “0” would represent “K” and “1” would represent “W.” The next three letters can be any one of 26 alphabet letters. A minimum of 5 bits (capable of 32 binary combinations) is required for each remaining letter. For example, a letter “A” would be represented by “00000” and a letter “Z” would be represented by “11001.” Alternatively, the call letters could be stored in ASCII, hex, decimal or another format depending upon the system and the memory available.

FIG. 3 illustrates a block-out table of the audio broadcast stations incorporating designated block-out times. Incorporating block-out times allows the user to block out only a temporary portion of a broadcast segment as opposed to the entire broadcast. The call letters of the audio broadcast station are stored in the table entries of block-out table using the 16 bit binary code. The block-out time is included as a table entry for the designated audio broadcast station in the block-out table 22. The user can select the current audio broadcast station that is tuned to or choose from an existing list of audio broadcast stations broadcasting in the geographical region already stored in the radio receiver 10. The user enters a start time and a stop time via the human machine interface. The microcontroller 24 will automatically start the block-out and terminate the block-out without any additional entries from the user. The times are in military time, but alternatively, other methods of tracking time can also be used.

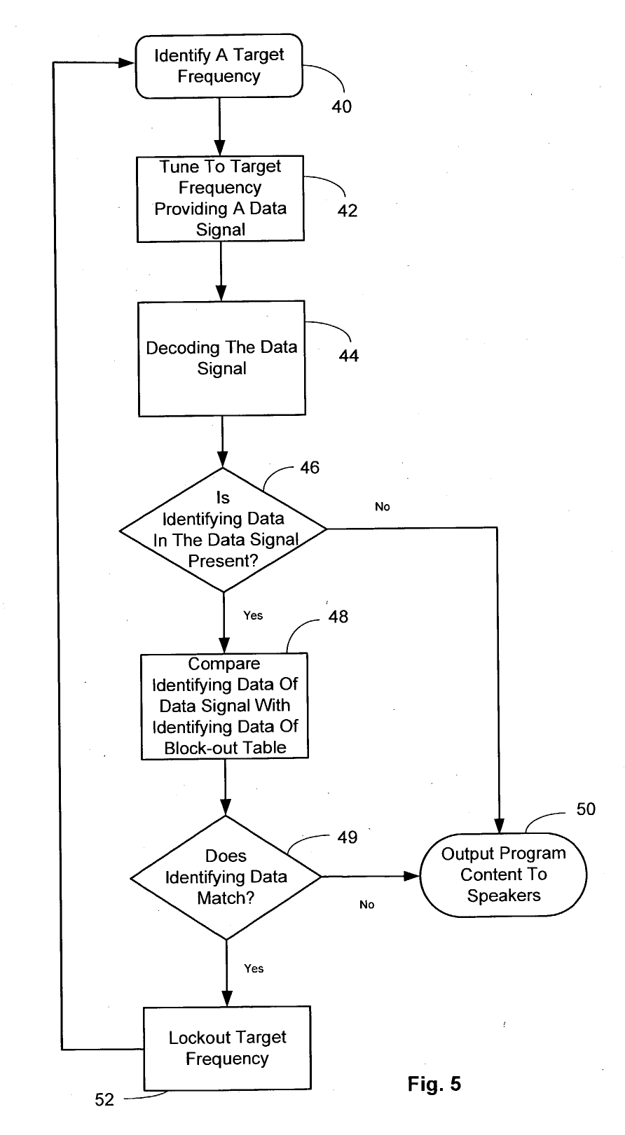

FIG. 4 illustrates a block-out table for a type of genre that is undesirable to a listener. The block-out table is constructed incorporating the different types of genre including jazz, classical, country, rock, reggae, hip-hop, and punk. The listener selects the genre from a list already existing and stored in the radio receiver. The listener then assigns a “1” indicating the genre is to be blocked out or a “0” indicating the indicating the genre is not to be blocked out. When the radio receiver 10 receives and decodes the audio broadcast signal, the microcontroller 24 will compare a code contained in the audio broadcast signal with the genre listed in the block-out table 22. If the code in the audio broadcast signal matches a type of genre flagged in the block-out table 22 to be blocked out, then the controller will lock out the audio broadcast signal for as long as the matching genre code is present.

FIG. 5 illustrates a flowchart for blocking out an audio broadcast station broadcasting undesirable program content. In step 40, the target frequency channel is identified that potentially contains the audio signal for outputting to the speakers or some type of output device. In step 42, the listener performs a tune operation to the frequency channel providing the audio signal. The tune operation includes any type of method used to select the frequency of the audio broadcast station such as a seek function, scan function, preset memory, or incrementing frequencies in a broadcast band. In step 44, the receiver decodes the audio signal containing a data signal. The data signal may contain the identifying data providing information such as the station call letters or the genre currently being broadcast by the audio broadcast station. Step 46 determines if the identifying data contained in the data signal is present. If the identifying data is not present, then the program content is output to the speakers or other receiving units in step 50. If the identifying data is determined to be present in step 46, then the microcontroller compares the identifying data of the data signal with the identifying data of the block-out table in step 48. Step 49 determines if the identifying data of the data signal matches the identifying data of the block-out table. If the identifying data of the data signal does not match the identifying data of the block-out table, then the program content is output to the speakers in step 50. If the identifying data does match, then the broadcast station is locked out in step 52.

If the preset memory operation or the frequency increment operation is used to select the target frequency channel, then the microcontroller will mute the audio and a message may be displayed indicating that the audio broadcast station is blocked out. The receiver will wait until the listener manually identifies and tunes to the next target frequency channel. Alternatively, the receiver can be programmed to automatically identify and tune to the next target frequency channel.

If the scan or seek operation is used to select the target frequency channel, then the microcontroller bypasses the audio broadcast station located at the target frequency channel and automatically identifies and tunes to the next successive target frequency channel without the listeners awareness.

In addition, a target frequency channel can be blocked out during a specific period of time. When the microcontroller determines that the identifying data of the data signal matches the identifying data of the block-out table (e.g., call letters), the microcontroller then determines if further limitations have been set by the block-out table such as the start time and the stop time to block-out a specific program segment of the audio signal for the designated audio broadcast station.

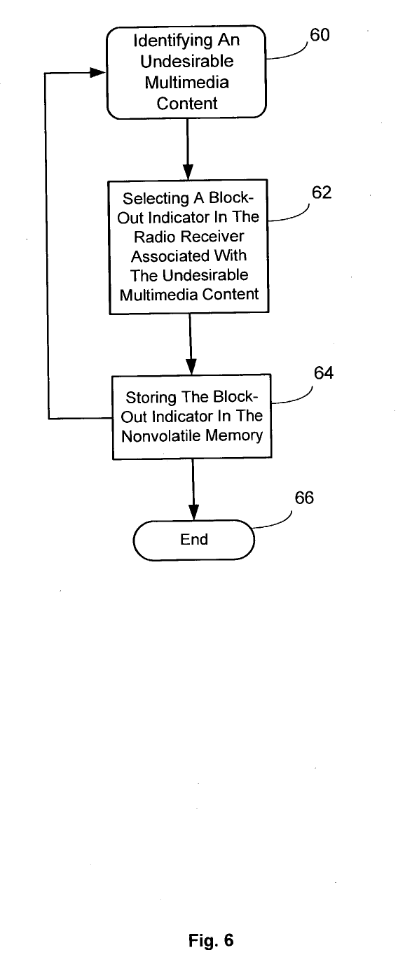

FIG. 6 illustrates a method for constructing a block-out table according to a first preferred embodiment. In step 60, an authorized user identifies an undesirable multimedia content. In step 62 the authorized user selects a block-out indicator in the radio receiver associated with the undesirable multimedia content. The selection can be made using the human machine interface of the receiver. In step 64, the block-out indicator is stored in the nonvolatile memory. If the authorized user decides to update the block-out table further a return to made to step 60 to update the block-out table otherwise the block-out table update is terminated in step 66.

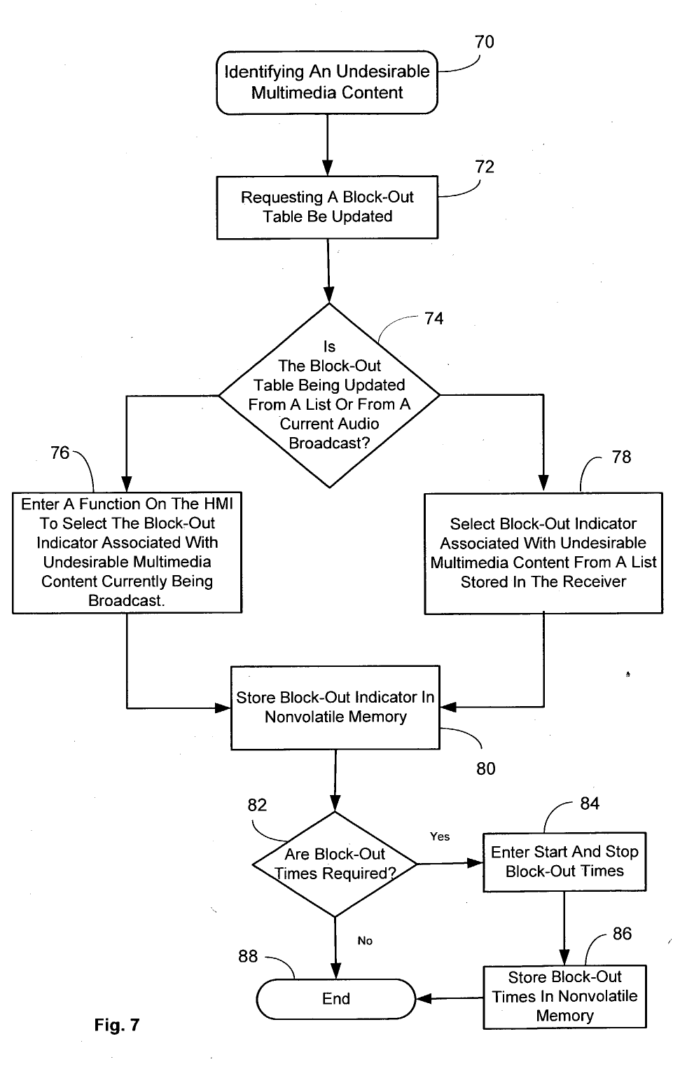

FIG. 7 illustrates a method for constructing a block-out table according to a second embodiment. An authorized user identifies the undesirable multimedia content in step 70. Undesirable multimedia content can be a type of genre or a programming content associated with a particular audio broadcast station. In step 72, the authorized user requests that the block-out table be updated. The request can be a selection that places the receiver into an update mode (e.g. a scrolling list) for further selections or the request can be a direct input on the human machine interface that directly updates the block-out table in response to the current broadcast. Entry into the block-out table update mode may preferably require entry of a password via the human machine interface. In step 74, a determination is made whether the block-out table is being updated from the list stored in the receiver or from a current audio broadcast being received by the receiver. In step 76, if the block-out table is being updated from the current audio broadcast, then a block-out indicator associated with the undesirable multimedia content is selected from the human machine interface. The block-out indicator selection can be made using respective push buttons for selecting the audio broadcast station transmitting the undesirable multimedia content or the type of genre of the undesirable multimedia content, for example. If the block-out table is being updated from the list stored in the receiver, then the block-out indicator associated with the undesirable multimedia content is selected from the list by manipulating user controls in step 78. In step 80, the block-out indicator is stored in the nonvolatile memory. In step 82, a determination is made whether block times are required for a designated block-out indicator. The block-out times are useful when the authorized user knows that a specific audio broadcast station will be broadcasting undesirable program content during a specific period of time. In step 84, the start and stop block-out time is entered into the receiver. The start time and stop time can be directly keyed or dialed in using the human machine interface or the times may be chosen from a list. In step 86, the block-out times are stored in the nonvolatile memory. If the block-out times are not required in step 82, then the block-out table update is terminated in step 88 or the user may return to step 70 to update the block-out table further.

What is claimed is:

1. A method of blocking audio and multimedia data of an audio broadcast station in a radio receiver wherein said audio broadcast station provides an audio signal at a target frequency channel, wherein said audio signal contains a data signal, wherein said receiver includes a tuner for selecting said frequency range of said target frequency channel and a decoder for decoding said data signal, and wherein said data signal contains an identifying data related to station and programming content of said audio signal, said method comprising the steps of:
identifying said target frequency channel for potentially receiving said audio signal;
tuning to said target frequency channel providing said audio signal;
decoding said data signal;
receiving said identifying data from said data signal;
comparing said identifying data of said data signal with a stored identifying data in a block-out table; and
locking out said target frequency channel when said identifying data of said audio signal matches said identifying data of said block-out table.

2. The method of claim 1 wherein said locking out step includes a mute audio operation when said tuning is in a preset memory mode or a channel increment mode.

3. The method of claim 2 further comprising the step of displaying a message to a listener that said audio station is locked-out.

4. The method of claim 1 wherein said radio receiver includes a display for displaying said multimedia data and wherein said locking out step includes blocking out said multimedia data displayed on said radio receiver.

5. The method of claim 1 wherein said locking out step includes a bypass audio operation when said tuning is in a scan mode or a seek mode.

6. The method of claim 1 wherein said audio signal includes an analog signal and said identifying data is an RBDS data.

7. The method of claim 1 wherein said audio signal includes a digital signal and said identifying data is a digital data.

8. The method of claim 1 wherein said identifying data includes a station identification code.

9. The method of claim 1 wherein said identifying data includes a program format code.

10. The method of claim 1 wherein said identifying data includes a genre code.

11. The method of claim 1 wherein said identifying data includes a broadcast type code.

12. A method of constructing a block-out table in a radio receiver, wherein said block-out table is used for blocking out a broadcast station broadcasting an undesirable multimedia program content, the method comprising the steps of:
a user identifying said undesirable multimedia content;
said user selecting a block-out indicator in said radio receiver for indicating that a broadcast station transmitting an identification code matching said block-out indicator is to be blocked out when said broadcast station is selected for reception; and
storing said block-out indicator in a nonvolatile memory.

13. The method of claim 12 further comprising the steps of entering said undesirable multimedia content including a start block-out time and a stop block-out time for blocking out said undesirable program content between a designated time.

14. The method of claim 12 wherein said identification code includes a station identification code.

15. The method of claim 14 wherein said station identification code includes station call letters.

16. The method of claim 12 wherein said identification code includes a type of genre.

17. The method of claim 12 wherein said block-out indicator includes a binary code.

18. The method of claim 12 wherein said block-out indicator includes an ASCII code.

19. The method of claim 12 wherein said user selecting said block-out indicator by operating a human machine interface when undesired content is being reproduced.

20. The method of claim 12 wherein said user selecting said block-out indicator from a list stored in said receiver.
